(19) United States
(12) Patent Application Publication
(10) Pub. No.: US 2006/0218394 A1
(43) Pub. Date: Sep. 28, 2006

(54) Organizational role-based controlled access management system

(76) Inventor: Dung Cheng Yang, Taipei (TW)

Correspondence Address: THORPE NORTH & WESTERN, LLP., 8180 SOUTH 700 EAST, SUITE 200, SANDY, UT, 84070, US

(21) Appl. No.: 11/091,041

(22) Filed: Mar. 28, 2005

(51) Int. Cl. H04L 9/32; H04L 9/00; G06F 17/30; G06F 7/04; G06K 9/00; H03M 1/68; H04K 1/00; H04N 7/16

(52) U.S. Cl. 713/167; 726/27; 713/165; 713/166

(57) ABSTRACT

An Organizational Role-based Access Controlled Management System capable of controlling role-based access within an organization allows system analysts or managers to build and control access roles for the various application systems within an organization. This system can also allow an end-user to choose the functions of the application systems and logon rights associated with the role. The system includes one or more personal computers and a server based on an event-driven mechanism. System analysts and end-users access synchronized data to manage the end-users' access roles. This system allows a system analyst to build and limit “set and set” relationships, as well as “member and set” relationships to pass information and manage organizational networks, roles, functions, privileges, etc. Different roles under various application systems can have different access rights and functions assigned. This system breaks away from the limitation of the conventional RBAC (Role Based Access Control) and allows system analysts to manage and adapt access roles according to the practical needs of different users and their complicated relationships to the organization and one another.

### BACKGROUND OF THE INVENTION

1. Field

The invention is in the field of security systems known as Role-Based Access Control (RBAC) systems or access role system for computer systems.

2. State of the Art

An “access role system” usually has a tree-like structure. In this structure, the administrator of each department has his/her own access role control branch to manage access roles of the members in his/her department. A system analyst can grant access privileges to managers at different levels, including creating and limiting access to application systems, as well as manage the relationships among roles and their associated privileges. If an organization's manager(s) is also a role system manager, he will be able to delegate his subordinates' roles and privileges, as well as distribute roles and access privileges in order to manage work duties and division of labor.

Each end-user within his/her department in the organization has his/her access role and rights to the application systems; i.e., each end-user possesses his/her access role as well as the application functions granted by the access role. Each end-user's logon and access role on the system of his/her department within the organization can also be set up. End-users can logon to each application system and obtain his/her assigned functions through an “end-user-role-privilege-function” relation. The system ensures centralized logon and avoid duplicated logons and passwords among systems.

The distribution of the role and rights among organizations is dynamic, not only the network structure will be changed at any time, but also the needs for roles and rights of end-users. To keep the operation of organizations smooth as well as sharing resources, there is a need for a management system which will enable system analyst to set up departments and corresponding roles and rights. At the same time the end-users will be granted appropriate role and rights.

Upon RBAC's definition, a role can only inherit rights from the top down; i.e. if role R1 inherits R2's role, then all the end-users under R1 will own the same rights R2 owns. A system analyst can cut down the cost by simplifying role and rights management. In general, roles tree structure relation is the same as the organization tree structure. But in the real world the inheritance does not represent the complicated network structure. For example, a hospital might have different rights for departments (family medicine, cardiology, internal medicine . . . ), function role (doctor, nurse . . . ), job title (director, manager, dean . . . ), job duty (desk job, receiving, janitor . . . ), combined group (family medicine director, internal medicine doctor, non-internal medicine doctor, internal medicine doctor with more than 5 years of service . . . ), etc. To manage complicated relations between groups (combined group, for example) using a simple tree structure is very difficult, it will need the managers to set up and maintain different groups manually. When an end-user's role is changed, the manager needs to modify the end-user's role and rights manually. Also, from the view of the organization, the same department might have different upper departments or administrators at different times. It is impossible to manage such complicated relations just using a simple (RBAC) role.

### SUMMARY

According to the invention, a computerized system solves dynamic role and rights problems among organization networks by managing role and rights distribution among the network structure to achieve resource sharing and centralized management. The invention provides a computerized system, method, and computer readable media to manage complicated network organization relations and roles. It allows system analyst to set up complicated network organizations through setting up different sets of groups and relations. Managers and end-users can use appropriate system functions under specific roles.

This system can be installed on one or many personal computers and a server. A personal computer will include a CPU, memory, display unit, input unit, and system associated function equipment. The system combines the end-user, organization, role, job title, and job duty using the same logic into different kinds of sets for management. It creates different relation and attributes for different “member and set” and “set and set”. The system analyst can add, modify, or delete any relation and its attributes to manage the system, organization structure, role set up, and function rights.

There is an event driven function to synchronize the data between the system servers and other system servers. The system analyst sets up organization department manager, role and rights based on account set up principles to set up information inside an event handler, and therefore synchronize the event.

When a system analyst sets up management rights, he/she also sets up functions and roles of the application system, and the relation between rights and roles. At the same time, the system analyst will transmit the information to achieve the purpose of synchronization.

End-users can obtain desired function rights of the application system through logon and password. The system processes the request by comparing logon and password.

‘Network set transmission’ is another aspect of this invention. The name of “network” in this invention is formed by the following elements: 1. Members, 2. Sets, 3. Member and Set Relation, 4. Set and Set Relation. Different members connect to different ‘Sets’ through different ‘Member and Set’ relations and all kinds of ‘Sets’ connect each other through different ‘Set and Set” Relations, which forms the network.

‘Members’ can be ‘end-user’ or any items which need to do the access-control, ‘function’, ‘permission’, ‘data item’, ‘device’, etc.

‘Sets’ can be any ‘Members’ which connect each other together through ‘Member and Set’ Relation, for example: Organization, Role, Right, Job Title, Work Item, etc.

‘Member and Set’ Relations can be any items needed in the access-control system, for example: Managed by, Manage, Contains, Report to, Group by, Delegate, Assign to, etc.. The ‘Member and Set’ Relation contains some attributes, for example, direct or indirect relation, whether it is allowed to transfer the relation through ‘Set and Set’ relation to get the result of ‘indirect relations of the member and set’, etc.. For example: if OU1 contains OU2 and a user U1 belongs to OU2 then the U1 indirectly belongs to OU1. But, if the user MU1 manages the OU2, it doesn't mean the MU1 manages the OU1. The relation of ‘user belongs to’ is allowed to transfer through the relation of “organization contains” but the relation of ‘user manages to’ is not allowed to transfer.

‘Set and Set’ relation can be any relation between any sets, for example,: the Top-Down relation between Organizations, the inheritance relation between Roles, the authorized relation between Organizations and Roles, the path of workflow (business process) relation between Organizations or Roles.

‘Set and Set’ relation contains attributes, for example,: the operation of And, Or, Not, None, the restrictions of conditions, is it allowed to transfer the relation of ‘Member and Set’ Relations to get result of ‘indirect relation of the sets and members’, whether it is allowed to transfer the relation of ‘Set and Set’ relations to get the result of ‘indirect relation of the sets and sets’, etc.

“Network set transmission” is another aspect of this invention. This invention about the relation of set and application is not limited by the application of member and its set, it can group different members by relations and attributes of different sets by passing information among sets and then checking relation of new member and set to for easy management. For example, passing function (permission) among role sets and members among organization sets will grant different permission to different departments, and therefore expand the basic RBAC's end-user and role relation as well as role and rights relation. Using the above-mentioned method, different combination of sets and members can be built to manage complicated network access-control management.

Based on “network set transmission” methods, system analysts can create different set relations using a more flexible method to set up relations including passing member permissions and not limited by RBAC's inheritance. Passing member relations can define a set member who is also a member of other sets using logical operands such as And, Or, Not, or None and other criteria. It can expand the original RBAC inheritance (Or) not to be limited by ‘uses-roles-permissions’, but also include all the members (for example: users, function permissions, data permissions, information permissions, etc.) and sets (for example: departments, roles, job titles, job duties, groups, etc.).

According to this invention's “network set transmission”, system analysts can create different groups based on different “member and set” relations and “set and set” relations. The relation between “set and set” or “member and set” can be obtained through groups. The relation can also be passed across groups or within groups.

As a summary, this invention provides a new method, system, and computer software so that system analysts can manage system access-control for departments, and also allow end-users to obtain appropriate system functions granted by associated role, departments or any user-groups.

### THE DRAWINGS

In the accompanying drawing:

FIG. 1A is a schematic representation of a computer system using the invention and showing a personal computer and server layout;

FIG. 1B, a block diagram showing components of a server as used in the system of FIG. 1A;

FIG. 1C, a block diagram showing components of a personal computer as used in the system of FIG. 1A;

FIG. 2, a block diagram of a rights control model layout;

FIGS. 3A and 3B, a flowchart diagram of a department set up, access role and logon set up,

FIG. 4A to 4I, are dialog fields showing how to create access role using this invention;

FIG. 5A to 5C, are dialog fields showing how to set up management systems;

FIG. 6A to 6F, are dialog fields showing modifying or adding systems screens;

FIGS. 7A and 7B, are dialog fields showing end-user logon screen;

FIG. 8, a flowchart diagram showing how a member may be added to or deleted from a set;

FIG. 9, a flowchart diagram showing how a set's “member and set” relation based on its origin set members may be re-calculated;

FIG. 10, a flowchart diagram showing how a new relation may be created, delete or modified between two sets;

FIG. 11A, a block diagram showing an example of a “member and set” relation;

FIG. 11B, a block diagram showing an XOR diagram for the “member and set” relation of FIG. 11A;

FIG. 12, a block diagram showing a possible loop relationship between sets;

FIG. 13, a block diagram showing how “member and set” relation can include or exclude indirect relation;

FIG. 14, a block diagram showing how a “set and set” relation transmission can be different from “member and set” relation transmission (role and role management);

FIG. 15, a block diagram showing how different relations between member and set can be applied;

FIG. 16, a block diagram showing application among different kinds of members and sets (the relation between end-user and role, or between functions, rights and role);

FIG. 17, a block diagram showing a relation of different sets among same groups (management's and cost's relation, or management's and audition's relation);

FIG. 18, a block diagram showing an application of different groups;

FIG. 19, a block diagram showing a Pushup concept which provides another “member and set” relation other than direct and indirect relations; and

FIG. 20, a block diagram showing an implementation for a “Static Separation of Duty (SSD)” Relation of RBAC of the invention.

### DETAILED DESCRIPTION OF THE ILLUSTRATED EMBODIMENT

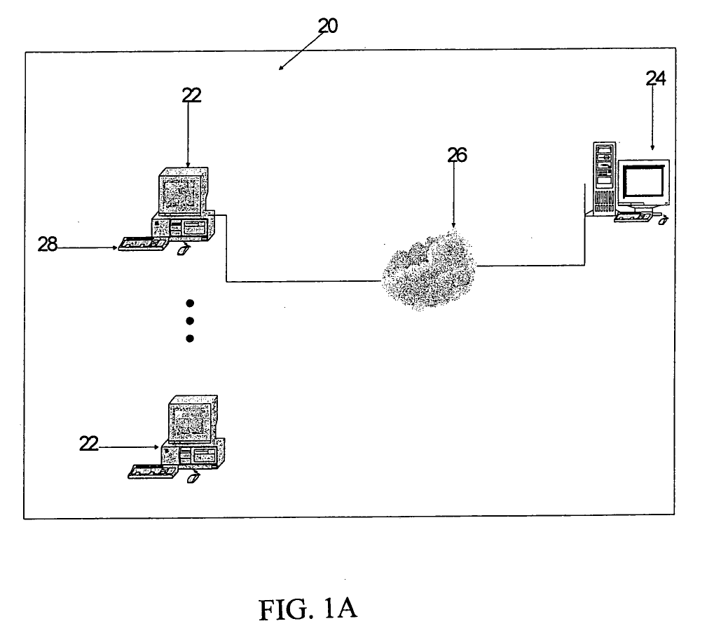

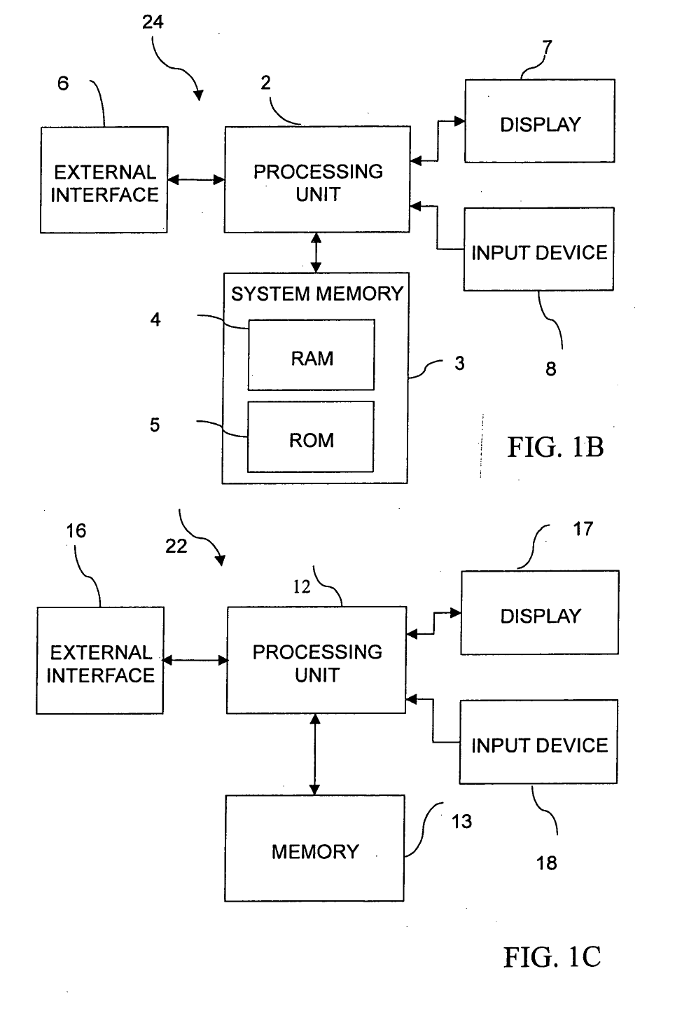

Demo system 20 (FIG. 1A) shows how the system is best used. System 20 includes one personal computer 22, connect to server 24 through public digital network 26. Personal computer 22 includes a display unit and at least one interface 28 to provide communication for system analyst and end-users. Personal computer 22 and server 24 include at least one CPU, memory, and data transmission and receiving devices. The system was installed in server 24 or both personal computer 22 and server 24.

FIG. 1A In accordance with the present invention, a server 24 receives a request from a client 22 via the Internet 26. The server 24 performs the requested, formats the results, and returns them to the requester, i.e., the client 22. The client 22 then displays the results. In the illustrated embodiment, the client is connected to the server via the Internet. However, it will be appreciated that the client 22 may be connected to the server 24 by other means, such as via an intra-network or remotely via a modem. The client 22 and server 24 can also be the same computer. Thus, the request can be performed on a stand-alone computer, as well as in a networked environment.

FIG. 1B depicts several of the key components of the server 24 used to implement the present invention. Those of ordinary skill in the art will appreciate that the server 24 includes many more components than those shown in FIG. 1B. However, it is not necessary that all of these generally conventional components be shown in order to disclose an illustrative embodiment for practicing the present invention. As shown in FIG. 1B, the server 24 includes a processing unit 2, a display 7, and a system memory 3. The system memory 3 generally comprises a random access memory (RAM) 4, read-only memory (ROM) 5, and a permanent mass storage device, such as a hard disk drive, tape drive, optical drive, floppy disk drive, or a combination thereof. The system memory 3 stores the program code and data necessary for performing a method of the present invention. Alternatively, at least some of the memory 3 may be coupled to a network, to which the server 24 is connected and through which the server 24 can access the memory 3, as opposed to physically residing in the server 24 itself.

The server 24 also includes an input device 8 and an external interface 6. The input device 8 may be implemented by a user of the server 24 to input data. The input device may be of any conventional type, such as a keyboard, mouse, track-ball, etc., or a combination thereof. The server 24 communicates to the client 22 through the external interface 6. In one actual embodiment of the present invention, the server is connected to a local area network, which in turn is connected to the Internet. Thus, the external interface 6 comprises a network interface card including the necessary circuitry for such a connection. The external interface 6 is also constructed for use with the Transmission Control Protocol/Internet Protocol (i.e., the standard transmission protocol for the Internet, also known as “TCP/IP”), the particular network configuration of the local area network it is connecting to, and a particular type of coupling medium. In other embodiments of the present invention, the external interface 6 comprises a modem.

As noted above, the client 22 sends the search request to the server 24, and the server 24 returns the search results to the client via a remote connection established by the external interface 6. The key components of the client 22 used to initiate a search request and display the search results are shown in FIG. 1C. Again, those of ordinary skill in the art will appreciate that the client 22 includes many more components than those shown in FIG. 1C. However, it is not necessary that all of these generally conventional components be shown in order to disclose an illustrative embodiment for practicing the present invention. The client 22 communicates with the server 24 over a remote connection via an external interface 16. In the actual embodiment of the present invention described herein, the client 22 is connected to a local area network, which in turn is connected to the Internet. Accordingly, external interface 16 includes the necessary circuitry for such a connection, and is also constructed for use with the TCP/IP protocol, the particular network configuration of a local area network it is connecting to, and a particular type of communication medium. In another embodiment of the present invention, the client's external interface 16 is a modem through which the client 22 may contact the server 24 directly.

In addition to the external interface 16, the client computer includes a display 17, a memory 13, and a processing unit 12. The memory 13 stores the search results provided by the server 24 and the program code implemented by the processing unit 12 for presenting the search results on the display 17, for example, using a Web browser.

Finally, the client 22 includes an input device 18, which may be implemented by a user to input the search request. The input device 18 may be of any conventional type, such as a keyboard, mouse, track-ball, etc., or some combination thereof.

A preferred embodiment of the invention is implemented using the Internet. However, it will be appreciated that other embodiments, such as a stand-alone computer, are possible. In the Internet embodiment shown and described herein, a user (i.e., client 22 in FIG. 1A) initiates a search by entering a search request in data entry fields displayed on a Web page. The search request is included as part of a Uniform Resource Locator (URL) that requests information from a World Wide Web server (e.g., server 24 in FIG 1A). The World Wide Web server parses the URL to obtain the request, response to the request, and returns the results to the requester. It will be appreciated that the requester need not be a user in the conventional sense (i.e., person), but may be, for example, a computer software application that automatically generates a request.

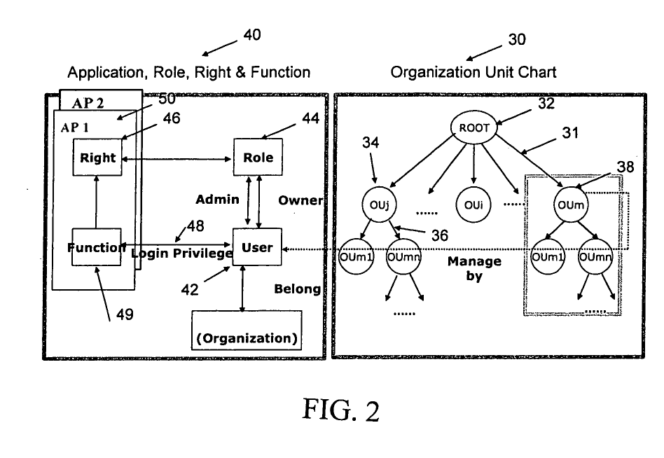

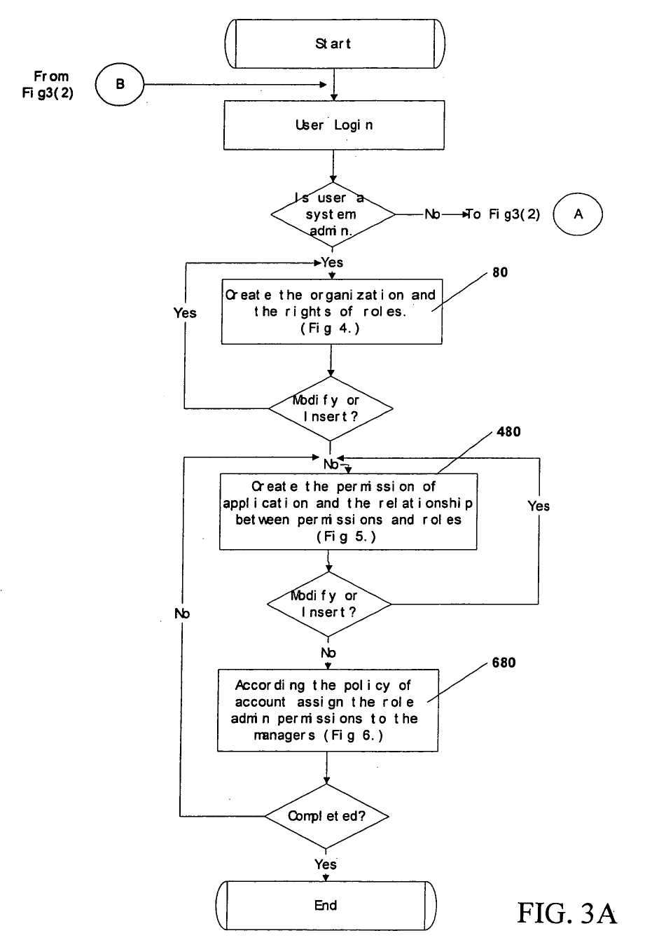

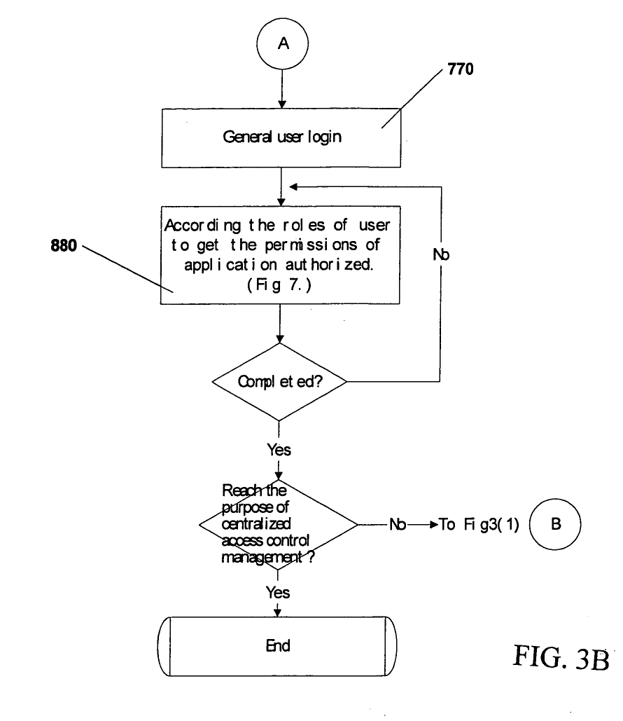

Organization administrator and role administrator are explained below based on the traditional tree structure's organization and role relation. In right side of FIG. 2, the organization structure 30 is a tree structure 31, node 34 represents department administrator, and branch 36 represents departments under the node. Every department belongs to either root 32 or another node 34. The OU administrator can manage all the end-users and leaf-end-users under this OU. The left of FIG. 2 shows end-users' and roles relation of end-users' access role and rights 40. If OUm administrator 38 is a system analyst as well as an end-user, we can assume manager=system analyst=end-user, then manager 38 is end-user 42, and therefore he owns 1 . . . M roles. If role 44 has rights 46 which owns function 1 . . . M, then end-user's 42 system login privilege 48 will have rights for function permission 49 of M×M. In another word an end-user's rights are defined by his role, the role's rights, and the functions permission the rights own. Every system login privilege 48 will obtain some functions permission through its rights, every end-user's role and rights set up the end-user's functions permission 50. Therefore, every OU administrator 34 and every end-user 42 will own his own functions and rights to distribute responsibility and resource sharing. See FIGS. 3-7 for more detailed explanation.

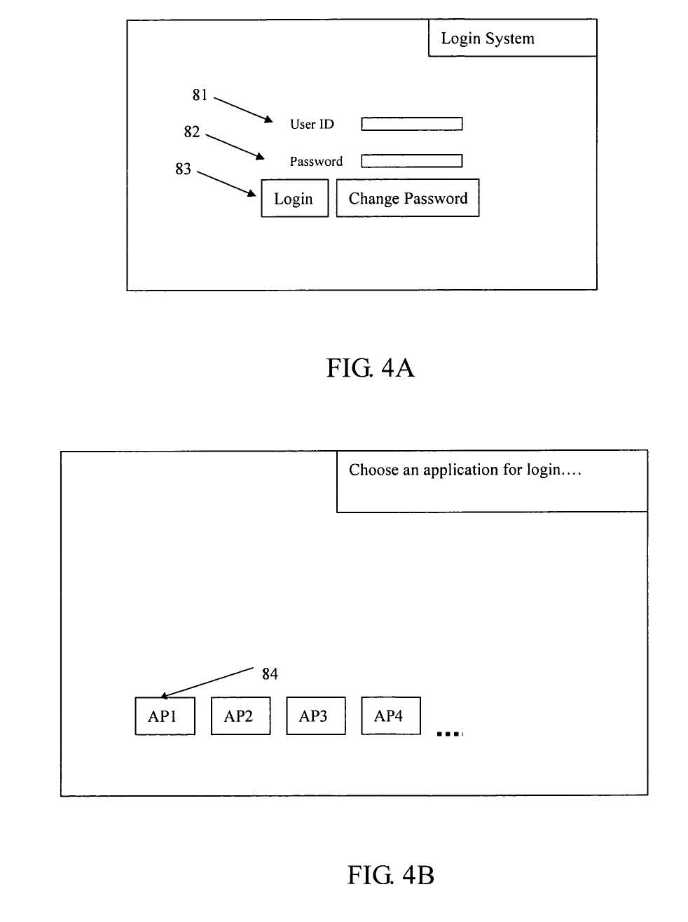

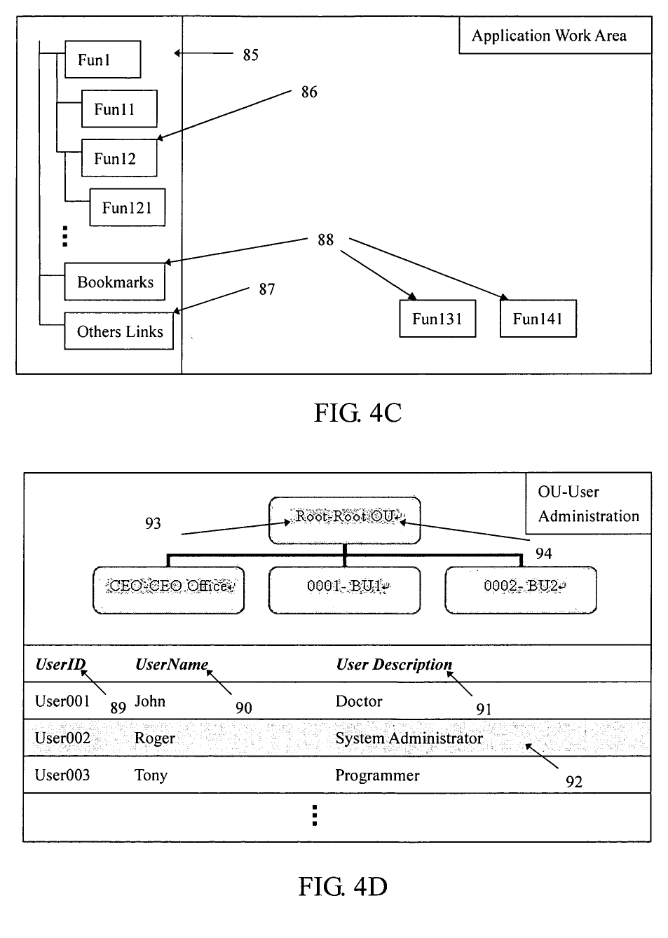

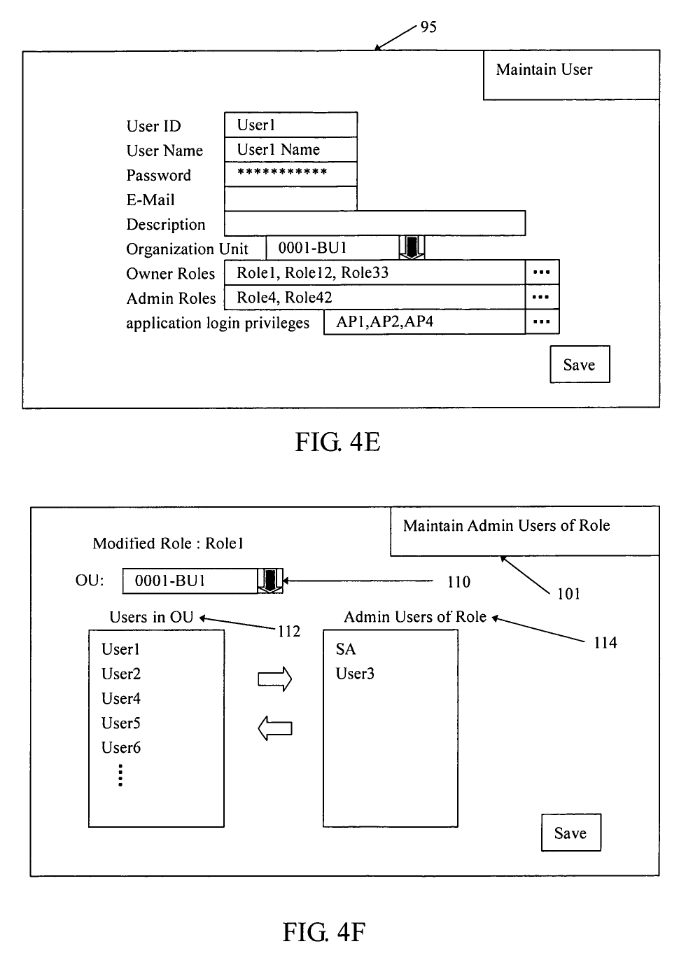

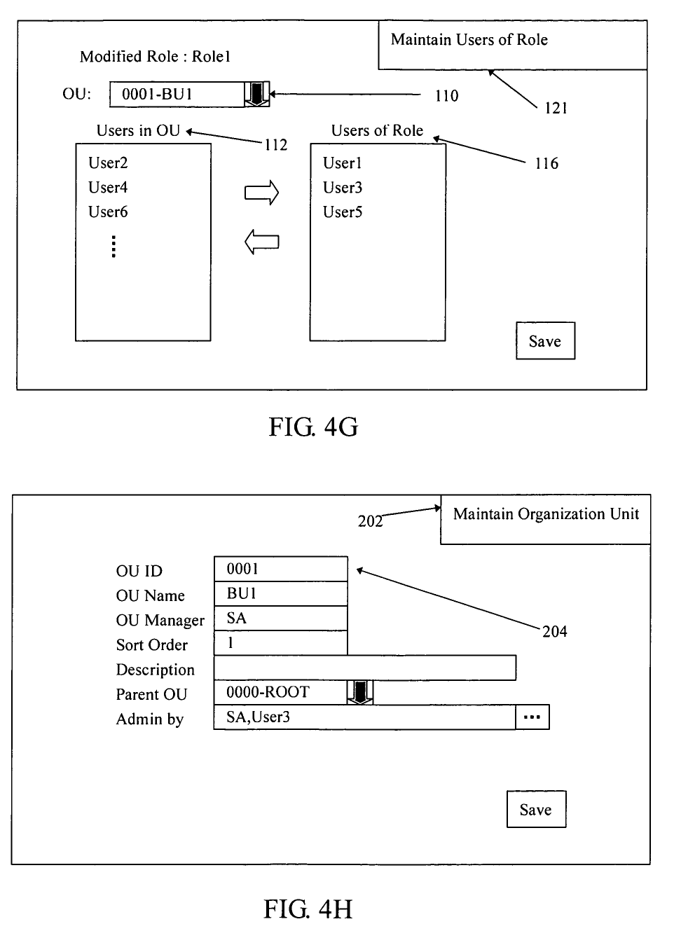

FIG. 3A shows how a user set up department and roles if this end-user is also a system administrator. An end-user logons from box 80, as shown in FIG. 4A; using logon 81 and password 82, enter system 83 as shown in FIG. 4B, it will display all the applications the end-user owns the login privilege. Upon entering box 84 as shown in FIG. 4C, the user will be able to get function list 86 though his rights from box 85, but it is not all the functions box 87, or other related functions 88 shown on this node. This system not only sets up functions permission, but also provides hierarchy control among the roles, organizations, user-groups tree. It sets up multiple end-users as administrators to manage department and user of its child nodes (leave). The lower part of FIG. 4 shows end-user 89 has name 90, job duty 91, and selected end-user 92. The upper part of FIG. 4D shows the functions the current logon end-user 92 owns department 93 and department name 94. FIG. 4E shows a user use Select Screen to modify or add new users, sets up new user's roles and his application login privileges.

FIG. 4F shows role administrator can set up end-user 112, his administer rights 114 through set up dialog field 101 by entering department 110. FIG. 4G shows an end-user with maintaining role can use dialog field 121 to set up user 112 and his role 116 by entering department 110. FIG. 4H shows a manager can modify department by using dialog field 202 to modify department name 204. To set up administrator of department after modifying department, shown in FIG. 41, use dialog field 303 to select administrator 307 among users 305.

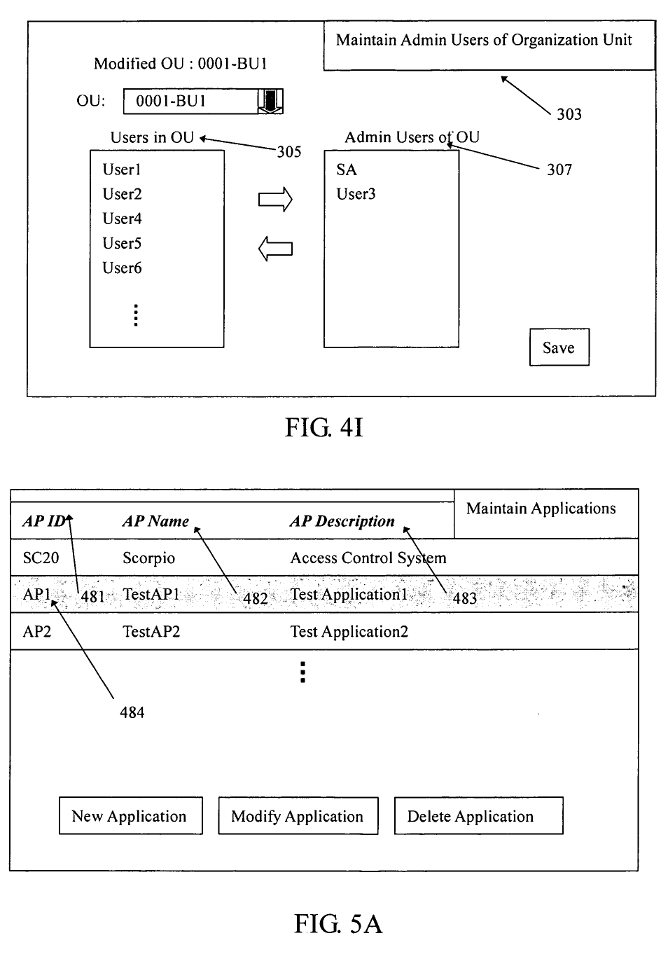

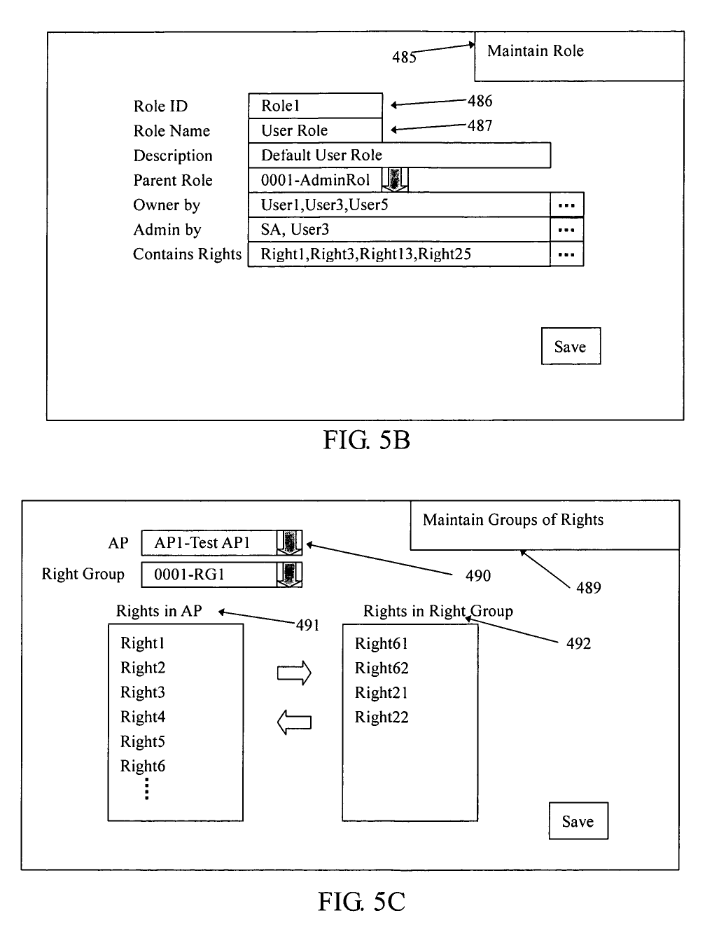

In FIG. 5A box 480, when an administrator builds application system management, just like FIG. 5A, by inputting system 480, name 482 and explanation 483 into management of access role control system, he can also include any new application system 484 into access role control system, as well as maintaining existing systems. Administrators can establish the relation of right and role, as shown in FIG. 5B and FIG. 5C, through the dialog field dialog field 485, input role 486 and role name 487 to modify the content of role. He can also set up rights Group through dialog field dialog field 489, rights 491 of input system 490, and the usage of rights 492.

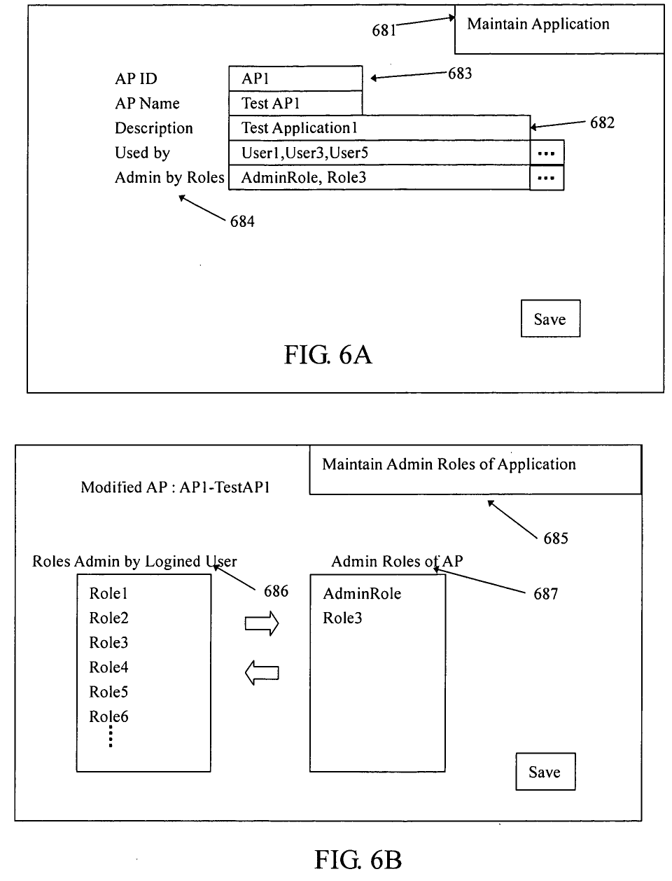

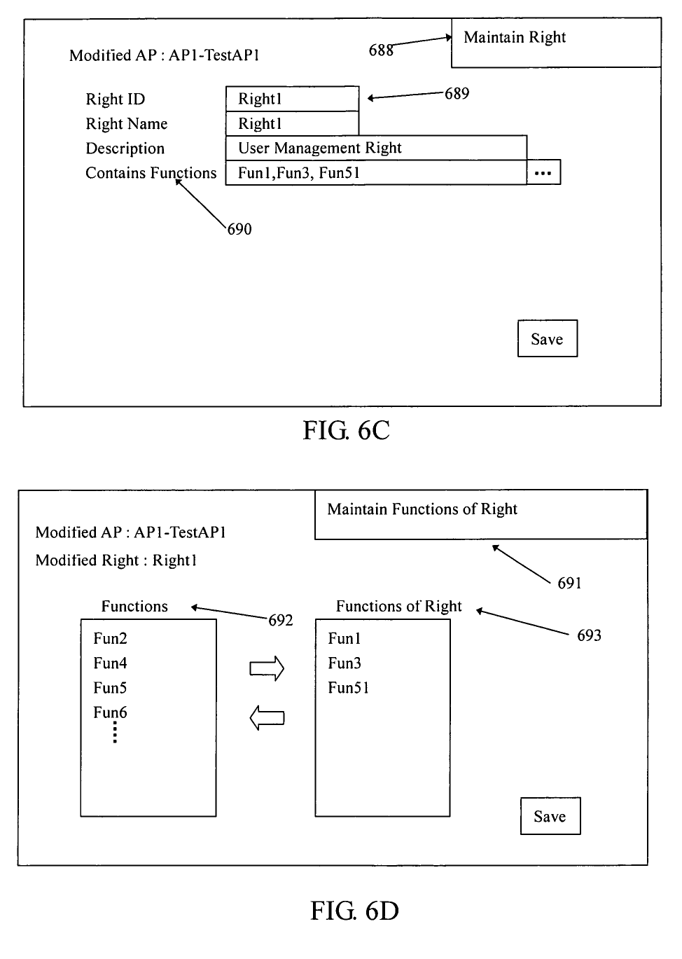

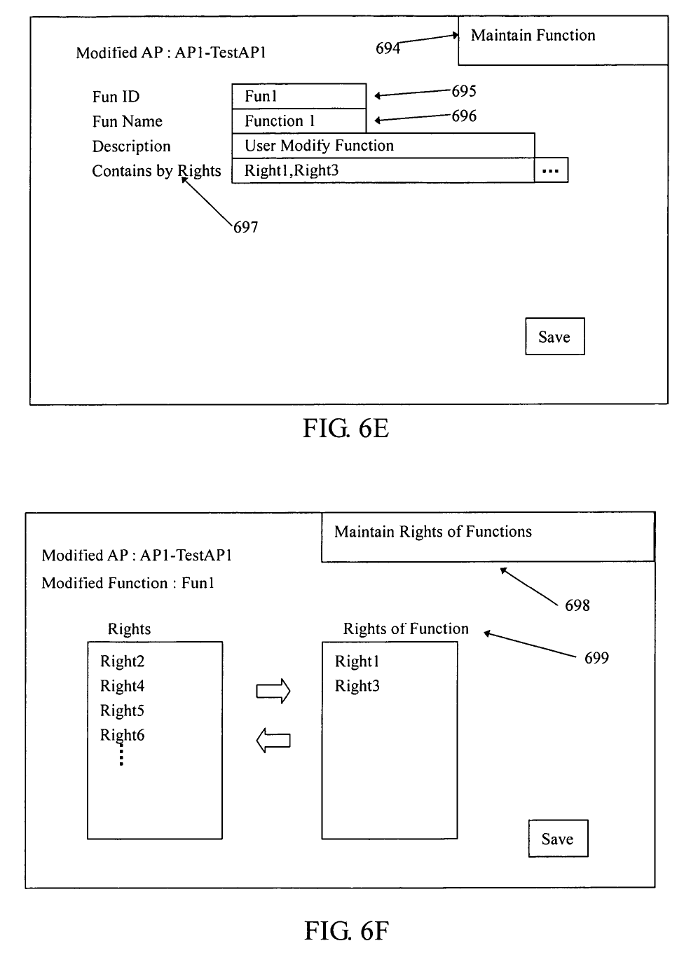

In FIG. 6A, when modifying or adding applications in a system, system role can be set up to apply management system 683 through modifying the content of system by dialog field dialog 681, input the explanation of the application 682, input application name 683, and activate application management roles 684. In FIG. 6B, selecting management privilege of role 687 can be done by through role in role 686 by using system management right set up dialog field, dialog field 685. In FIG. 6C, setting up the relation of rights and functions can be achieved by modifying the rights content in dialog field dialog field 688, the rights 689 of input application system, and activating function 690. In FIG. 6D, retrieving and own function 693 can be done through function set up dialog field dialog 691 to set up rights 689 and add and delete items in function 692. In FIG. 6E, inquiring the rights of ownership function 696 can be achieved by modifying the content of function through dialog field 694, input function id 695 and function name 696, maintaining the functions in the application system and activating right 697. In FIG. 6F, acquiring right 699 can be done by querying rights function in dialog field dialog field 698.

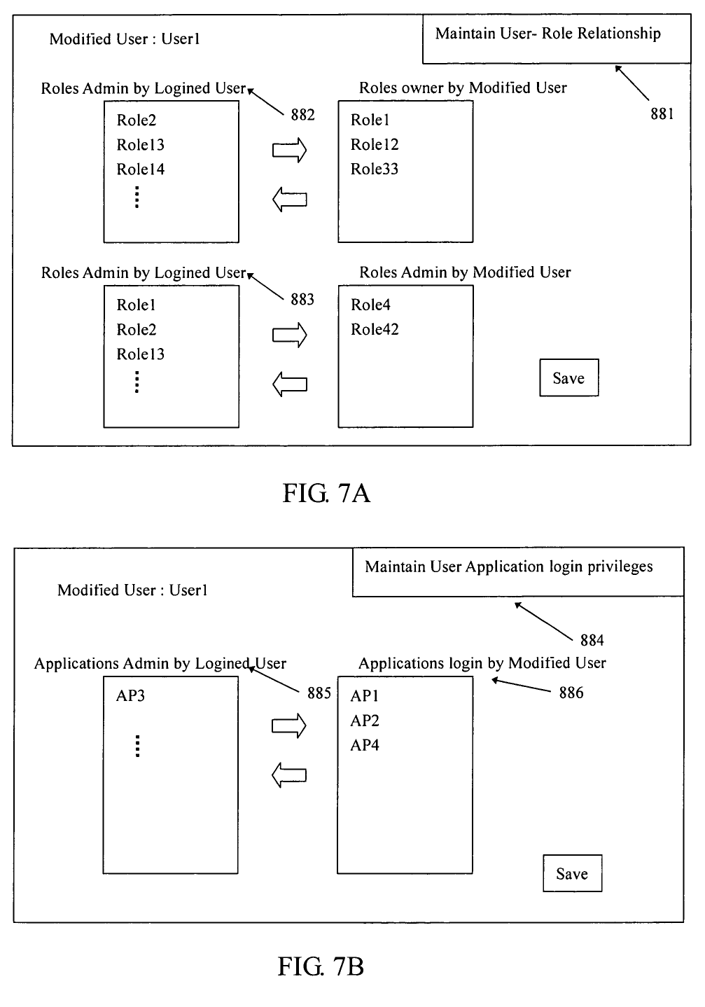

Form box 770 in FIG. 3B, when general end-users logon to the system, as shown in box 880, they can obtain functions in every application system through the relation of the function and rights, and end user and roles relation diagram. The relationship of end user and roles has two categories; one is the ownership of role to decide the authorization of function of the particular end user, the other is the authorization of the role to decide the authority of a particular's end user and how he/she can assign the authority to other role of end users. In FIG. 7A, to achieve the responsibility distribution and category of rights, by using the role setup dialog field, the role assignment field, dialog field 882 and 883, in the dialog field 881 to show the role of certain end users and combining their management right in organization. In FIG. 7B, deciding the application login privilege of end-user after logon can be achieved by modifying manager's set up system 885 and end-user logon system 886.

The “Network Set Transmission Theory” method of this system can be expanded to more complicated “set and set” relation of network transmission.

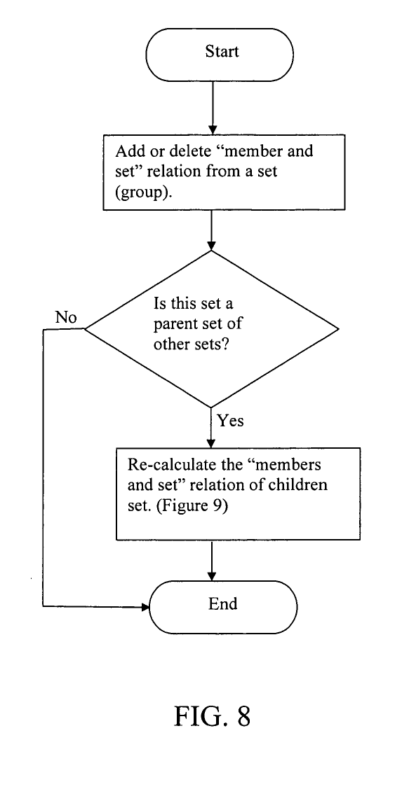

FIG. 8 shows how a member is added to or deleted from a set, its relation is passed by “member and set” of “set and set” relation.

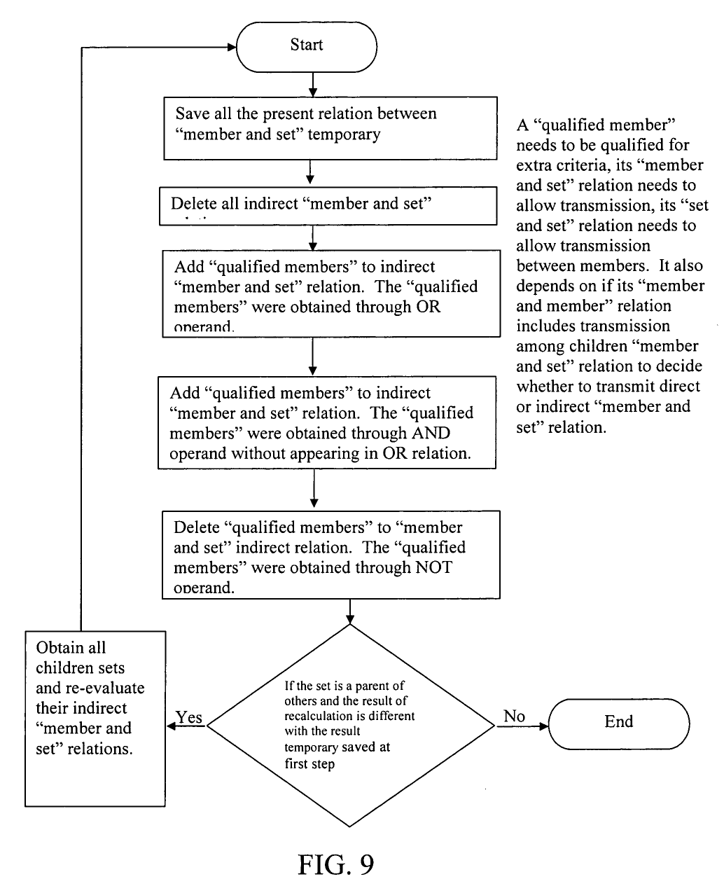

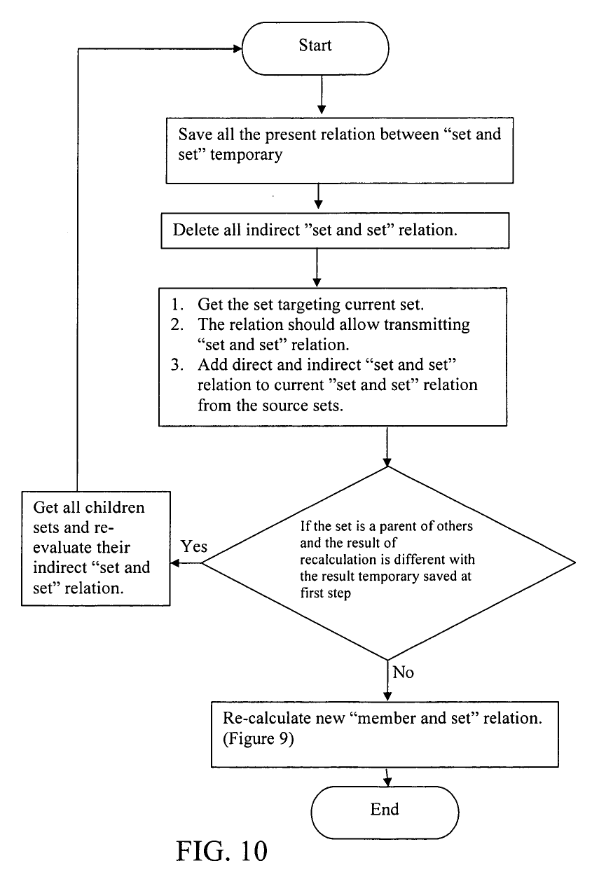

FIG. 9 shows how a set's “member and set” relation based on its origin set members can be re-calculated. When the direct “member and set” relation changed, we need to re-calculate the all indirect “member and set” relations of the sets connected by the “set and set” relation from the changed set. A “qualified member” needs to be qualified for extra criteria, its “member and set” relation needs to allow transmission, its “set and set” relation needs to allow transmission between members. It also depends on if its “member and member” relation includes transmission among children “member and set” relation to decide whether to transmit direct or indirect “member and set” relation.

FIG. 10 shows that when a new relation is created, deleted or modified between two sets, the “set and set” relation can be transmitted through other “set and set” relations. A set's direct or indirect relation can be queried very easily.

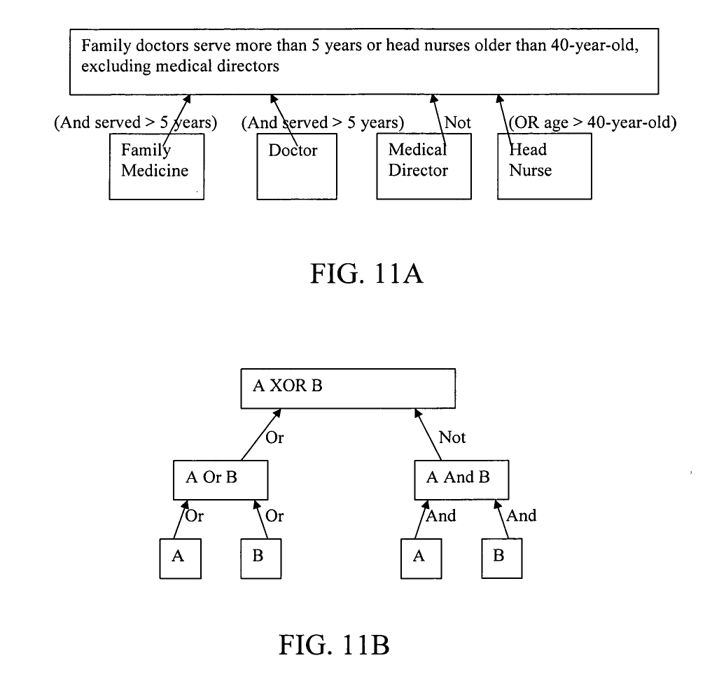

FIG. 11A shows an example “member and set” relation. It shows a set with “family doctors serve more than 5 years or nurse managers older than 40-year-old”, excluding medical directors, can be obtained by combining “family medicine set”, “doctor set”, “medical director set”, and “nurse manager set”. “Family medicine” is a department, “doctor” is a role, “medical director” and “nurse manager” are job duties. FIG. 11B shows an XOR diagram for the “member and set” relation of FIG. 11A.

FIG. 11B shows an XOR diagram÷for the “member and set” relation of FIG. 11A. It shows that A XOR B can be expressed as (A OR B) NOT (A AND B).

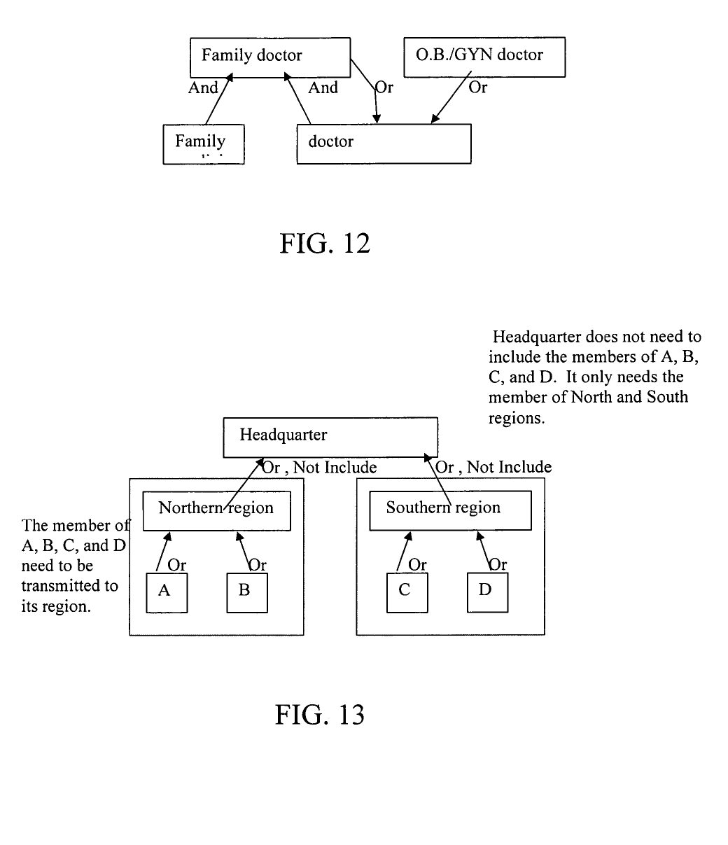

FIG. 12 shows a loop relationship between sets. “Family doctor” is a an intersect (AND operand) of “family medicine” and “doctor”. “Doctor” is union (OR operand) of “family doctor”, “OB/GYN doctor” etc. If an end-user is a member of “family medicine” and joins “doctor”, then this end-user becomes a member of “family doctor” automatically. There is a loop relation between “family doctor” and “doctor”. The loop will not exist if this end-user is not a “family medicine” member. When dealing with loop relationship: the relation of “set and set” and “member and set” must transfer until the relationship status stop change which means there will be no more change.

FIG. 13 shows that a “member and set” relation can include or exclude indirect relation. In the example of FIG. 13, each region will include its sub-region's members, but the headquarter will only include the members of regions, but not the sub-regions' members. Headquarter does not need to include the members of A, B, C, and D. It only needs the members of North and South regions. The members of A, B, C, and D need to be transmitted to its regions.

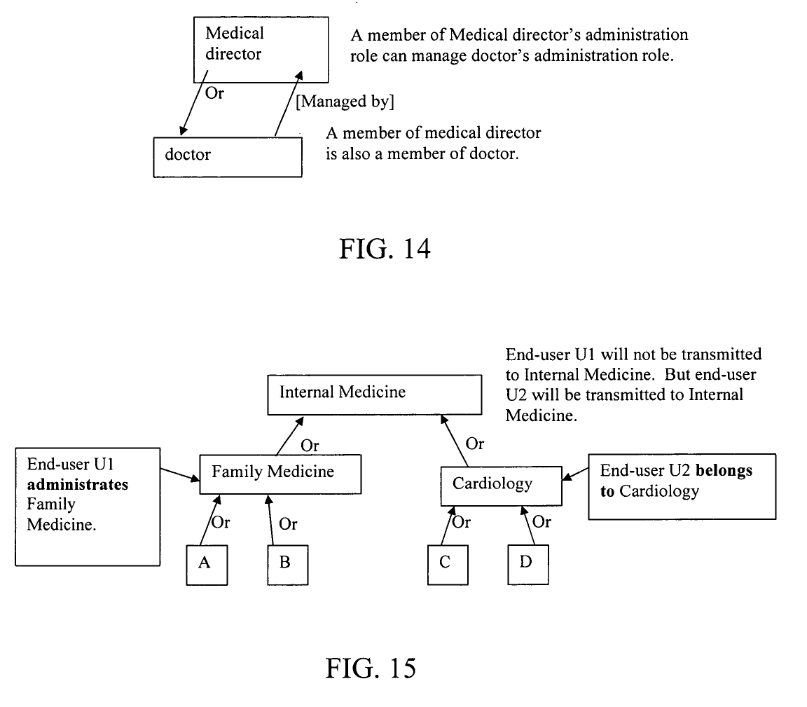

FIG. 14 shows a “set and set” relation transmission can be different from “member and set” relation transmission (role and role management.) Doctors include medical director's role and rights, but doctor administration role cannot manage medical director role. It is because medical director administration role should be greater than doctor administration role, therefore, medical director administration role should include doctor administration role. A doctor can have other administration role, medical director can have another administration role, there is role inclusion relation between the two sets, but not administration inclusion relation.

FIG. 15 shows how to apply different relation between member and set. An end-user's administration role does not need to be transmitted. But an end-user's membership needs to be transmitted. End-user U1 will not be transmitted to Internal Medicine. But end-user U2 will be transmitted to Internal Medicine.

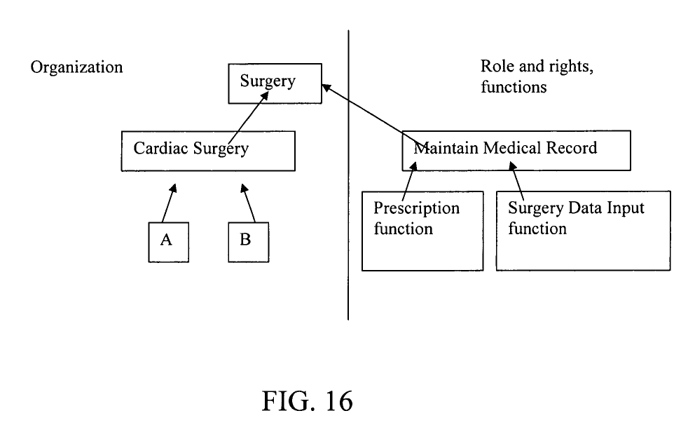

FIG. 16 shows application among different kind of members and sets (the relation between end-user and role, or between functions, rights and role). A function can be defined as a member of a set, and therefore becomes member of different function sets. The function set can relate to a role, and the role can be related to organization. Function set up can be transmitted, so the members of functions can be transmitted within departments of organization. From the relation of an end user in a particular department and the functions it owns, the right of an end-user in a particular organization department can be identified. When an end-user belongs to many departments, the union of function sets is this end-user's rights (functions permission).

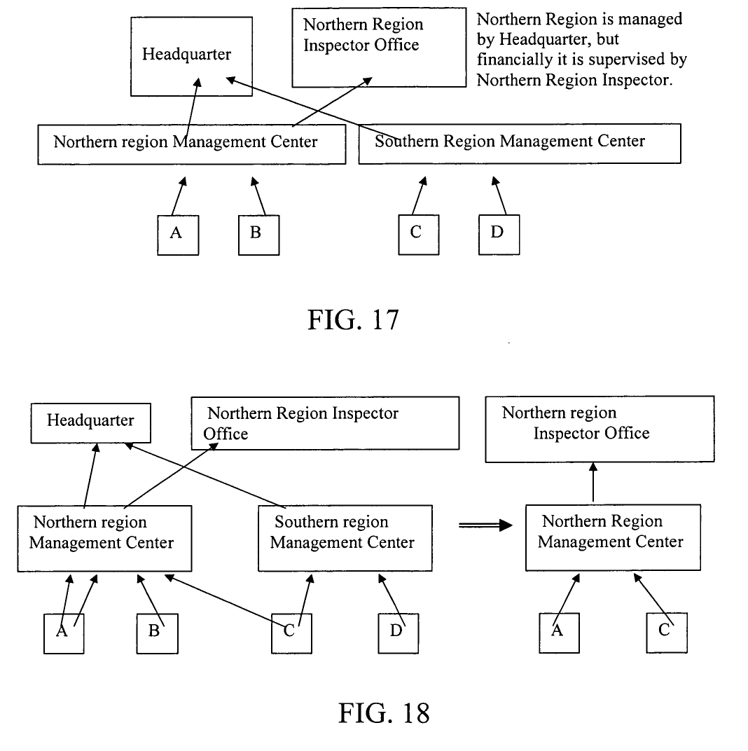

FIG. 17 shows the relation of different sets among same group (management's and cost's relation, or management's and audition's relation). As shown in the figure, a department is managed by its upper layer (Headquarter), but its financial is audited by another department (Northern Region Inspector office.) Thus, the Northern Region is managed by Headquarters, but financially it is supervised by the Northern Region Inspector.

FIG. 18 shows the application of different groups. (For example, the crossed groups application for groups of workflow (business process) or groups of end-users.) Different workflow path (business process) can create different parent-child relation, and a workflow's routing relation is not need to be an administration relation.

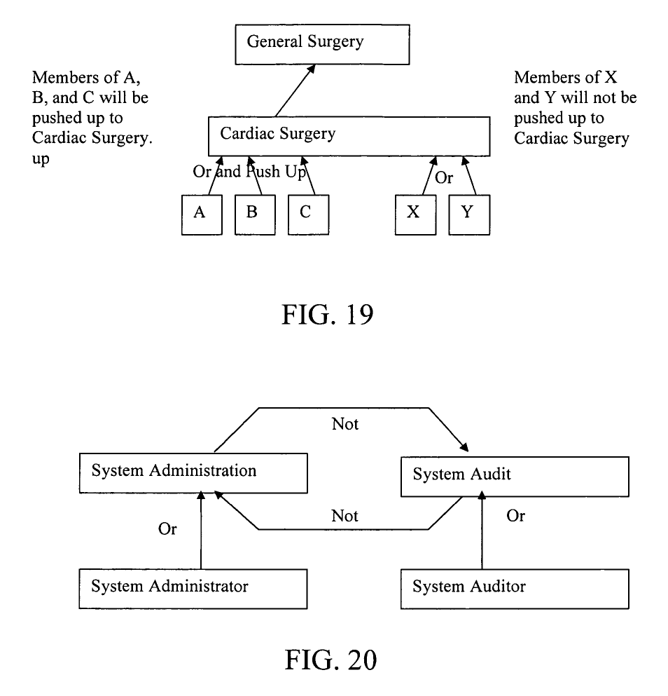

FIG. 19 shows a Pushup concept (Ex: internal team and sub-contractor.) There are three internal team members and two sub-contractors managed by a department. But from the organization's view the teams do not exist, the internal team members belong to the department, and the 2 two sub-contractors do not belong to any of the departments of the organization. The system analyst can avoid duplicated maintenance of virtual department and real department of the organization by using Pushup method. Thus, as shown in the example of FIG. 19, members of A, B, and C will be pushed up to Cardiac Surgery. Members of X and Y will not be pushed up to Cardiac Surgery. The Pushup method provides another “member and set” relation other than direct and indirect relation, and is best used in virtual department.

FIG. 20 shows an implementation for “Static Separation of Duty (SSD)” Relation of RBAC by this innovation. The system administrator role and supervisor role can not be given to same end-user, it needs to be connected by NOT relation. If an end-user owns both roles at the same time, he will end up with no roles at all.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. An organizational role-based controlled access management method, comprising:
a. creating a logon dialog field for end-users to input logon names and passwords in order to enter the system;
b. determining whether the end-user's department and appropriate end-user's access role and privileges (functions permission) have been established;
c. determining whether the end-user is a department manager or designated system analyst who may select to set up departments and/or roles, and if so:
(a) opening a manager's dialog field to display department(s) under the user's current management, and to display department(s) and associated rights tree(s);
(b) entering a role set up dialog field to display the roles and privileges available for the manager to distribute, and allow the manager to set up end-users' roles, and delimit the roles and rights the end-user can manage;
(c) entering a role assignment field to assign departments, roles, and privileges (functions permission) to end-users; and
(d) entering a systems set up dialog field to assign application systems to access roles;
d. determining whether the end-user is a department manager, and, if so, allowing the department manager to select to add or modify roles, privileges or functions to a new system or a new end-user, and, if a selection is made, then:
(a) entering a modify department dialog field, entering department name and code, and upper department it belongs to, and continue on modification;
(b) entering a modify role dialog field, which allows entering access role description and code, and continue on modification;
(c) entering a modify system dialog field, which allows entering system name, and continue on modification;
(d) entering a modify rights dialog field, which allows entering right description, and continue on modification;
(e) entering a modify function dialog field, which allows entering function description and code, and continue on modification;
e. determining whether the user is a normal end-user, and, if so, then:
(a) entering an entry dialog field which allows entering end-user's logon and password; and activating system functions and privileges associated with the user;
(b) entering an end-user's dialog field which allows selecting a desired application systems;
(c) entering the selected application systems, whereby the end-user can use the system with granted role and privileges, and predetermined functions.

2. An organizational role-based controlled access management method according to claim 1, further allowing addition of more than one end-user for any one tree node, additionally including:
f. entering a modify end-user dialog field, and adding or modifying a new end-user; and
g. setting up the new end-user's access role and system login privileges.

3. An organizational role-based controlled access management method according to claim 1, wherein the access role set up also includes:
h. entering the system set up field, and adding systems to the manager's control; and
i. assigning systems login privileges to the roles.

4. An organizational role-based controlled access management method according to claim 1, wherein the role assignment also includes:
j. entering the role maintenance dialog field, and assigning organizational department; and
k. displaying all end-users and access role managers within the department.

5. An organizational role-based controlled access management method according to claim 1, wherein modifying department also includes:
l. entering the set up department manager dialog field, to set up department; and
m. displaying all end-users and managers within the department.

6. An organizational role-based controlled access management method according to claim 1, wherein the access role modification also includes:
n. entering the privilege designation dialog field, and setting up login name, and
o. displaying associated system management and role assignment rights, as well as other approved privileges.

7. An organizational role-based controlled access management method according to claim 1, wherein the system modification also includes:
p. entering the system management set up dialog field, and selecting access role types and management roles and privileges.

8. An organizational role-based controlled access management method according to claim 1, wherein the modify privileges dialog field also includes:
q. a function set up dialog field, display of functions tree, and set up of functions.

9. An organizational role-based controlled access management method according to claim 1, wherein the function modification also includes:
r. entering the function-associated privileges dialog field, and setting up role function code and name.

10. An organizational role-based controlled access computer management system, utilizing a public digital network, and including
one or more personal computers and a server connected by a public digital network;
wherein each personal computer includes at least a memory, a display, and a data entry device that can communicate with application systems; wherein the server includes at least one processor to connect to a public digital network, computer programs, and a database; and wherein each personal computer also includes an event processing application to add, edit, delete, or modify access roles and privileges; and when an event occurs, the personal computer synchronizes with the server to update a user's access role and privileges; the system comprising:
s. a dialog field for logon and password;
t. means for processing and recognition of an end-user's department, role, and privileges;
u. means for access by manager(s) or system analyst(s) to set up organizational departments, role, privileges and limitations, including:
(a) a user function management field, display of the organizational department(s) and end-users subject to the current user's management, production and display of an organizational structure tree and the functions the manager can distribute to each end-user;
(b) an access role set up dialog field, display of available roles available to the manager to set up end-users' role and privileges;
(c) a role assignment dialog field, for input of organizational positions, end-users, and allowable role assignment(s);
(d) a system selection dialog field, to designate application system(s) for controlled access management by a manager(s);
v. means for department managers to add or modify the department personnel list, and manage the role and privileges assigned to end-users within the department, including:
(a) a department modification dialog field, to input and modify department names for subordinate departments;
(b) a role modification dialog field, to input and modify access role codes, and names;
(c) a system modification dialog field, to input and modify system name(s);
(d) a privilege modification dialog field, to input and modify privilege description(s);
(e) a function modification dialog field, to input and modify function codes and description;
w. means for identification of normal end-users, and processing requests for application systems and functions, including:
(a) a logon and password dialog field;
(b) an end-user dialog field for selecting a system from those which are available to the end-user;
(c) after logon, access to all of the privileges and functions available to the end-user.

11. An organizational role-based controlled access computer management system according to claim 10, wherein, if the system includes more than one end-user in the system, the system additionally includes:
x. means to modify end-user dialog field to add new end-user or modify end-user; and
y. means to set up end-user roles and system login privileges.

12. An organizational role-based controlled access computer management system according to claim 10, wherein role assignment also includes:
a system login privilege set up dialog field to allow systems managers to assign systems login privileges to end-users.

13. An organizational role-based controlled access computer management system according to claim 10, wherein role set up also includes:
z. a maintenance dialog field to enter department; and
aa. means to display all end-users and their roles of the department.

14. An organizational role-based controlled access computer management system according to claim 10, wherein modify department also includes:
bb. a set up department manager dialog field to allow set up of departments; and
cc. means to display all end-users and their managers of the department.

15. An organizational role-based controlled access computer management system according to claim 10, wherein modify access role also includes:
dd. a role set up dialog field, including a process for set up of role names; and
ee. means for designation of system management and end user role assignment privileges.

16. An organizational role-based controlled access computer management system according to claim 10, wherein system modification also includes:
a system management set up dialog field with processes to select management roles and set up associated management privileges.

17. An organizational role-based controlled access computer management system according to claim 10, wherein right (privilege) modification also includes:
ff. a function set up dialog field to display of a function tree structure; and
gg. means to set up and assign available functions.

18. An organizational role-based controlled access computer management system according to claim 10, wherein function modification also includes:
a function-related privileges dialog field to allow set up of privilege code numbers and descriptions.

19. An access control management method, comprising:
hh. creation of different domains;
ii. creation of different kinds of sets within the domains;
jj. creation of different kinds of members within the domains;
kk. designation of the relations between sets within the domains, setup of the “set and set” relations and associated transmission attributes;
ll. creation of “member and set” relations and associated attributes within the domains;
mm. recalculation of attributes, transmission, and indirect relations according to changes to the direct relations among “set and set” or “member and set” relations (e.g. new, delete, update); and
nn. retrieving relations data through the result of direct and indirect relations after transmission by a method selected from the group consisting of retrieving the relations data between one set and the other sets connected to it via direct or indirect “set and set” relations; retrieving the relations data between one set and members connected to it via direct or indirect “set and set” relations and “member and set” relations; and retrieving the relations data between one member and other members connected to it via direct or indirect “set and set” relation and “member and set” relations.

20. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes establishing the relation between sets can be also used to establish a variety of applications for building organizational charts from the relations between departments within the organization.

21. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the relations between members and sets to designate the different managers within the organization for different applications and through the methods of query between the sets, a variety of different mechanisms for management of the organization can also be queried.

22. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the relations between the members and sets to establish special mechanisms for special functions; special mechanisms being established for the special purposes of the existing organization and extra criteria.

23. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the relation between sets to establish the matrix of organization.

24. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the relation between “member and set” to determine whether a user belongs to some department directly or indirectly.

25. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the ‘belong to’ relation between “member and set” to query the users belong directly or indirectly to departments of the organization.

26. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the ‘manages’ relation between “member and set” to determine whether a user manages some department directly or indirectly.

27. An access control management method according to claim 19, wherein if:
The kind of set is organization
The kind of member is end-user
The kind of“set and set” relation is “organizational tree structure,” “matrix organization,” or “functional organization,” etc.
The kind of “member and set” relation is “belongs to the organization,” or “manages the organization” etc.
the method additionally includes using the relation between “set and set” (department relation) and “member and set” (user ‘belongs to’ or ‘manages’ a department ) to determine whether a user is under another user's management.

28. An access control management method according to claim 19, wherein if:
The kind of set is organization
The kind of member is end-user
The kind of “set and set” relation is “organizational tree structure,” “matrix organization,” or “functional organization,” etc.
The kind of “member and set” relation is “belongs to the organization,” or “manages the organization” etc.
the method additionally includes using the relation between “set and set” (department relation) and “member and set” (user ‘belongs to’ or ‘manages’ a department) to determine whether a user is under another user's management; and using the relations between “set and set” and “member and set” to determine if users are managed by a given manager, and vice-versa.

29. An access control management method according to claim 19, wherein if:
The kind of “set” is “role.”
The kind of “member” is “function,” or “privilege,” etc.,
The kind of “set and set” relation is “role association,” “role networking,” “role hierarchy,” “function set,” or “privilege set,” etc.
The kind of “member and set” relation is “functions or privileges under a role,” “group of functions,” or “group of privileges,” etc.,
the method additionally includes using the methods of establishing the relations between sets to establish a variety of role associations from the relations between the roles.

30. An access control management method according to claim 19, wherein if:
The kind of “set” is “role.”
The kind of “member” is “function,” or “privilege,” etc.,
The kind of “set and set” relation is “role association,” “role networking,” “role hierarchy,” “function set,” or “privilege set,” etc.
The kind of “member and set” relation is “functions or privileges under a role,” “group of functions,” or “group of privileges,” etc.,
the method additionally includes using the methods of establishing the relations between sets to establish a variety of role inheritance associations from the relations between the roles.

31. An access control management method according to claim 19, wherein if:
The kind of “set” is “role.”
The kind of“member” is “function,” or “privilege,” etc.,
The kind of “set and set” relation is “role association,” “role networking,” “role hierarchy,” “function set,” or “privilege set,” etc.
The kind of “member and set” relation is “functions or privileges under a role,” “group of functions,” or “group of privileges,” etc.,
the method additionally includes using the methods of establishing the relations between sets to transmit roles, functions, and privileges between the different roles with or without additional criteria to be combined with a given role's existing functions and privileges.

32. An access control management method according to claim 19, wherein if:
The kind of “set” is “role.”
The kind of“member” is “function,” or “privilege,” etc.,
The kind of “set and set” relation is “role association,” “role networking,” “role hierarchy,” “function set,” or “privilege set,” etc.
The kind of “member and set” relation is “functions or privileges under a role,” “group of functions,” or “group of privileges,” etc.,
the method additionally includes using the methods of establishing the relations between “set and set” to define “NOT” relations in order to achieve mutual exclusion.

33. An access control management method according to claim 19, wherein if:
The kind of “set” is “role.”
The kind of“member” is “function,” or “privilege,” etc.,
The kind of “set and set” relation is “role association,” “role networking,” “role hierarchy,” “function set,” or “privilege set,” etc.
The kind of “member and set” relation is “functions or privileges under a role,” “group of functions,” or “group of privileges,” etc.,
the method additionally includes using the methods for transmission of the relations between “member and set” to determine if certain functions or privileges are directly or indirectly associated with a given role after transmission.

34. An access control management method according to claim 19, wherein if:
The kind of “set” is “role,”
The kind of “member” is “end-user,”
The kind of “set and set” relation is “role association,” “role network,” or “role hierarchy,” etc.,
The kind of “member and set” relation is “end-user's role,” or “role's administrator,” etc.,
the method additionally includes using the methods of establishing “member and set” relations to set up an end-user's role.

35. An access control management method according to claim 19, wherein if:
The kind of “set” is “role,”
The kind of “member” is “end-user,”
The kind of “set and set” relation is “role association,” “role network,” or “role hierarchy,” etc.,
The kind of “member and set” relation is “end-user's role,” or “role's administrator,” etc.,
the method additionally includes using the methods of establishing “member and set” relations to designate roles managed by an end-user.

36. An access control management method according to claim 19, wherein if:
The kind of “set” is “role,”
The kind of“member” is “end-user,”
The kind of “set and set” relation is “role association,” “role network,” or “role hierarchy,” etc.,
The kind of “member and set” relation is “end-user's role,” or “role's administrator,” etc.,
the method additionally includes using the methods of establishing “set and set” relations to set up the transmissions and the relations between roles.

37. An access control management method according to claim 19, wherein if:
The kind of “set” is “role,”
The kind of “member” is “end-user,”
The kind of “set and set” relation is “role association,” “role network,” or “role hierarchy,” etc.,
The kind of “member and set” relation is “end-user's role,” or “role's administrator,” etc.,
the method additionally includes using the methods used to query the relations between ‘member and set’ after transmission, to check if a role includes a user directly or indirectly via transmission.

38. An access control management method according to claim 19, wherein if:
The kind of “set” is “role,”
The kind of “member” is “end-user,”
The kind of “set and set” relation is “role association,” “role network,” or “role hierarchy,” etc.,
The kind of “member and set” relation is “end-user's role,” or “role's administrator,” etc.,
the method additionally includes using the methods used to query the relations between ‘member and set’ after transmission, can be used to check if an end-user manages a role via transmission.

39. An access control management method according to claim 19, wherein if:
The kind of “set” is “job title,” or “job duty,” etc.,
The kind of “member” is “end-user,”
The kind of “set and set” relation is “hierarchy of job tiles”, or “hierarchy of job duties,” etc.,
The kind of “member and set” relation is “end-user's job title,” “end-user's job duty,” “job title administrator,” “job duty administrator,” etc.
the method used to set up “member and set” relations can be used to set up administrators of job titles and job duties.

40. An access control management method according to claim 19, wherein if:
The kind of “set” is “job title,” or “job duty,” etc.,
The kind of “member” is “end-user,”
The kind of “set and set” relation is “hierarchy of job tiles”, or “hierarchy of job duties,” etc.,
The kind of “member and set” relation is “end-user's job title,” “end-user's job duty,” “job title administrator,” “job duty administrator,” etc.\
the method used to set up “member and set” relations can be used to set up a variety job titles and job duties for end-users, etc.

41. An access control management method according to claim 19, wherein if:
The kind of “set” is “job title,” or “job duty,” etc.,
The kind of “member” is “end-user,”
The kind of “set and set” relation is “hierarchy of job tiles”, or “hierarchy of job duties,” etc.,
The kind of “member and set” relation is “end-user's job title,” “end-user's job duty,”“job title administrator,” “job duty administrator,” etc.
the method used to set up “set and set” relations can be used to create a special purpose set with different job titles and job duties.

42. An access control management method according to claim 19, wherein if:
The kind of “set” is “job title,” or “job duty,” etc.,
The kind of “member” is “end-user,”
The kind of “set and set” relation is “hierarchy of job tiles”, or “hierarchy of job duties,” etc.,
The kind of “member and set” relation is “end-user's job title,” “end-user's job duty,” “job title administrator,” “job duty administrator,” etc.
the method used to set up “set and set” relations can be used to set up the relations between job sets and role sets to manage an end-user's authorized functions by job titles or job duties.

43. An access control management method according to claim 19, wherein the sets, members, “set and set” relations or “member and set” relations can be created in different domains; and the method used to set up “set and set” relations among different domains can be used to create different flow sequences for workflow control.

44. An access control management method according to claim 19, wherein the sets, members, “set and set” relations or “member and set” relations can be created in different domains; and the method used to set up different workflow and domain relations can be used to set up different workflow using different organizational structures.

45. An access control management method according to claim 19, wherein the sets, members, “set and set” relations or “member and set” relations can be created in different domains; and the method used to set up different “member and set” relations can be used to set up approval relations and different end-users' relations among different workflow.
